(19) United States
(12) Patent Application Publication
(10) Pub. No.: US 2026/0138495 A1
(43) Pub. Date: May 21, 2026

(54) HYBRID VEHICLE AND CORRESPONDING CONTROL SYSTEM

(71) Applicant: FORD GLOBAL TECHNOLOGIES, LLC, Dearborn, MI (US)

(72) Inventors: Xiaohong DUAN, Canton, MI (US); Yonghua LI, Ann Arbor, MI (US); Richard Dyche ANDERSON, Plymouth, MI (US)

(21) Appl. No.: 18/954,852

(22) Filed: Nov. 21, 2024

(51) Int. Cl. B60L 58/14

(52) U.S. Cl. CPC B60L 58/14; B60L 2240/545; B60L 2240/547

(57) ABSTRACT

A vehicle includes an electric machine, a battery, and a controller. The battery is configured deliver power to the electric machine to propel the vehicle. The controller is programmed to, in response to a voltage of the battery decreasing to less than a first threshold while the battery is discharging and a rate of change of the voltage of the battery increasing to greater than a second threshold during the discharging, reduce a discharging power of the battery based on a proportion of a difference between the first threshold and the voltage and a proportion of a difference between the rate and the second threshold.

### TECHNICAL FIELD

The present disclosure relates to hybrid and electric vehicles and batteries for hybrid and electric vehicles.

### BACKGROUND

Hybrid and electric vehicles may be propelled by an electric machine that draws power from a battery.

### SUMMARY

A vehicle includes a battery and a controller. The battery is configured deliver power to an electric machine to propel the vehicle. The controller is programmed to, while discharging power from the battery at a commanded value and in response to a rate of change of a voltage of the battery increasing to greater than a threshold rate during the discharging, reduce the discharging power to less than the commanded value based on a proportion of a difference between the rate and the threshold rate. The controller is further programmed to, while discharging power from the battery at the commanded value and in response to the rate remaining less than the threshold rate during the discharging, maintain discharging the battery at the commanded value.

A vehicle includes an electric machine, a battery, and a controller. The battery is configured deliver power to the electric machine to propel the vehicle. The controller is programmed to, in response to a voltage of the battery decreasing to less than a first threshold while the battery is discharging and a rate of change of the voltage of the battery increasing to greater than a second threshold during the discharging, reduce a discharging power of the battery based on a proportion of a difference between the first threshold and the voltage and a proportion of a difference between the rate and the second threshold.

A vehicle includes a battery and a controller. The battery is configured deliver power to an electric machine to propel the vehicle. The controller is programmed to, while discharging power from the battery at a commanded value and in response to a voltage of the battery decreasing to less than a voltage threshold during the discharging, reduce the discharging power from the commanded value to less than the commanded value based on a proportion of a difference between the voltage threshold and the voltage.

### BRIEF DESCRIPTION OF THE DRAWINGS

FIG. 1 is a schematic illustration of a representative powertrain of an electric vehicle that includes a battery;

FIGS. 2A-2D are a series of graphs comparing the terminal voltage of the battery according to various models relative to test data;

FIG. 3 is a schematic illustration of an equivalent circuit model that is representative of the battery;

FIG. 4 is flowchart illustrating a method of estimating the power capability of the battery;

FIG. 5 is a flowchart illustrating a method for controlling the power output of the battery; and

FIG. 6 is a graph illustrating the power output of the battery when controlled based on the methods described with respect to FIGS. 5 and 6.

### DETAILED DESCRIPTION

Embodiments of the present disclosure are described herein. It is to be understood, however, that the disclosed embodiments are merely examples and other embodiments may take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the embodiments. As those of ordinary skill in the art will understand, various features illustrated and described with reference to any one of the figures may be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

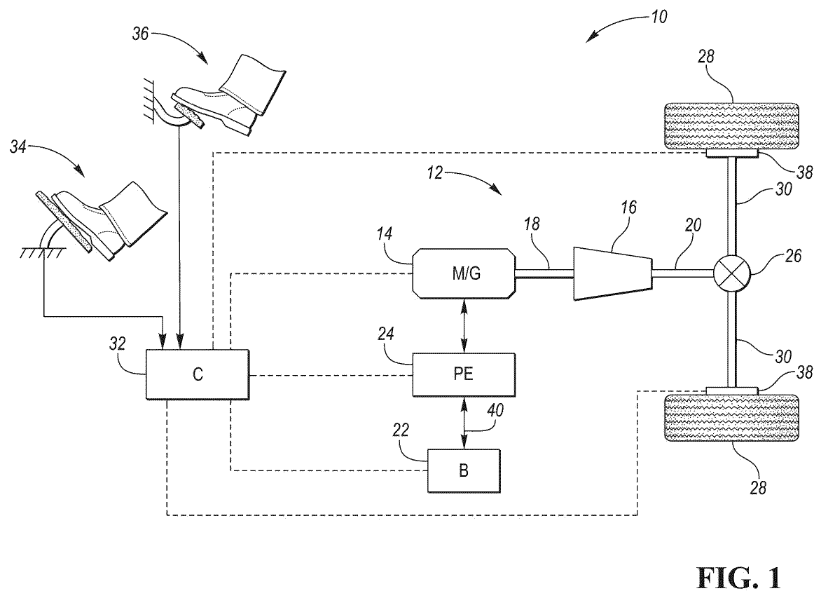

Referring to FIG. 1, a schematic diagram of an electric vehicle 10 is illustrated according to an embodiment of the present disclosure. FIG. 1 illustrates representative relationships among the components. Physical placement and orientation of the components within the vehicle may vary. The electric vehicle 10 includes a powertrain 12. The powertrain 12 includes an electric machine such as an electric motor/generator (M/G) 14 that drives a transmission (or gearbox) 16. More specifically, the M/G 14 may be rotatably connected to an input shaft 18 of the transmission 16. The transmission 16 may be placed in PRNDSL (park, reverse, neutral, drive, sport, low) via a transmission range selector (not shown). The transmission 16 may have a fixed gearing relationship that provides a single gear ratio between the input shaft 18 and an output shaft 20 of the transmission 16. A torque converter (not shown) or a launch clutch (not shown) may be disposed between the M/G 14 and the transmission 16. Alternatively, the transmission 16 may be a multiple step-ratio automatic transmission. An associated traction battery 22 is configured to deliver electrical power to or receive electrical power from the M/G 14.

The M/G 14 is a drive source for the electric vehicle 10 that is configured to propel the electric vehicle 10. The M/G 14 may be implemented by any one of a plurality of types of electric machines. For example, M/G 14 may be a permanent magnet synchronous motor. Power electronics 24 condition direct current (DC) power provided by the battery 22 to the requirements of the M/G 14, as will be described below. For example, the power electronics 24 may provide three phase alternating current (AC) to the M/G 14.

If the transmission 16 is a multiple step-ratio automatic transmission, the transmission 16 may include gear sets (not shown) that are selectively placed in different gear ratios by selective engagement of friction elements such as clutches and brakes (not shown) to establish the desired multiple discrete or step drive ratios. The friction elements are controllable through a shift schedule that connects and disconnects certain elements of the gear sets to control the ratio between the transmission output shaft 20 and the transmission input shaft 18. The transmission 16 is automatically shifted from one ratio to another based on various vehicle and ambient operating conditions by an associated controller, such as a powertrain control unit (PCU). Power and torque from the M/G 14 may be delivered to and received by transmission 16. The transmission 16 then provides powertrain output power and torque to output shaft 20.

It should be understood that the hydraulically controlled transmission 16, which may be coupled with a torque converter (not shown), is but one example of a gearbox or transmission arrangement; any multiple ratio gearbox that accepts input torque(s) from a power source (e.g., M/G 14) and then provides torque to an output shaft (e.g., output shaft 20) at the different ratios is acceptable for use with embodiments of the present disclosure. For example, the transmission 16 may be implemented by an automated mechanical (or manual) transmission (AMT) that includes one or more servo motors to translate/rotate shift forks along a shift rail to select a desired gear ratio. As generally understood by those of ordinary skill in the art, an AMT may be used in applications with higher torque requirements, for example.

As shown in the representative embodiment of FIG. 1, the output shaft 20 is connected to a differential 26. The differential 26 drives a pair of drive wheels 28 via respective axles 30 connected to the differential 26. The differential 26 transmits approximately equal torque to each wheel 28 while permitting slight speed differences such as when the vehicle turns a corner. Different types of differentials or similar devices may be used to distribute torque from the powertrain to one or more wheels. In some applications, torque distribution may vary depending on the particular operating mode or condition, for example.

The powertrain 12 further includes an associated controller 32 such as a powertrain control unit (PCU). While illustrated as one controller, the controller 32 may be part of a larger control system and may be controlled by various other controllers throughout the vehicle 10, such as a vehicle system controller (VSC). It should therefore be understood that the powertrain control unit 32 and one or more other controllers can collectively be referred to as a “controller” that controls various actuators in response to signals from various sensors to control functions such as operating the M/G 14 to provide wheel torque or charge the battery 22, select or schedule transmission shifts, etc. Controller 32 may include a microprocessor or central processing unit (CPU) in communication with various types of computer readable storage devices or media. Computer readable storage devices or media may include volatile and nonvolatile storage in read-only memory (ROM), random-access memory (RAM), and keep-alive memory (KAM), for example. KAM is a persistent or non-volatile memory that may be used to store various operating variables while the CPU is powered down. Computer-readable storage devices or media may be implemented using any of a number of known memory devices such as PROMs (programmable read-only memory), EPROMs (electrically PROM), EEPROMs (electrically erasable PROM), flash memory, or any other electric, magnetic, optical, or combination memory devices capable of storing data, some of which represent executable instructions, used by the controller in controlling the engine or vehicle.

The controller 32 communicates with various vehicle sensors and actuators via an input/output (I/O) interface (including input and output channels) that may be implemented as a single integrated interface that provides various raw data or signal conditioning, processing, and/or conversion, short-circuit protection, and the like. Alternatively, one or more dedicated hardware or firmware chips may be used to condition and process particular signals before being supplied to the CPU. As generally illustrated in the representative embodiment of FIG. 1, controller 32 may communicate signals to and/or receive signals from the M/G 14, battery 22, transmission 16, power electronics 24, and any another component of the powertrain 12 that may be included, but is not shown in FIG. 1 (i.e., a launch clutch that may be disposed between the M/G 14 and the transmission 16. Although not explicitly illustrated, those of ordinary skill in the art will recognize various functions or components that may be controlled by controller 32 within each of the subsystems identified above. Representative examples of parameters, systems, and/or components that may be directly or indirectly actuated using control logic and/or algorithms executed by the controller 32 include front-end accessory drive (FEAD) components such as an alternator, air conditioning compressor, battery charging or discharging, regenerative braking, M/G 14 operation, clutch pressures for the transmission gearbox 16 or any other clutch that is part of the powertrain 12, and the like. Sensors communicating input through the I/O interface may be used to indicate wheel speeds (WS1, WS2), vehicle speed (VSS), coolant temperature (ECT), accelerator pedal position (PPS), ignition switch position (IGN), ambient air temperature (e.g., ambient air temperature sensor 33), transmission gear, ratio, or mode, transmission oil temperature (TOT), transmission input and output speed, deceleration or shift mode (MDE), battery temperature, voltage, current, or state of charge (SOC) for example.

Control logic or functions performed by controller 32 may be represented by flow charts or similar diagrams in one or more figures. These figures provide representative control strategies and/or logic that may be implemented using one or more processing strategies such as event-driven, interrupt-driven, multi-tasking, multi-threading, and the like. As such, various steps or functions illustrated may be performed in the sequence illustrated, in parallel, or in some cases omitted. Although not always explicitly illustrated, one of ordinary skill in the art will recognize that one or more of the illustrated steps or functions may be repeatedly performed depending upon the particular processing strategy being used. Similarly, the order of processing is not necessarily required to achieve the features and advantages described herein, but is provided for case of illustration and description. The control logic may be implemented primarily in software executed by a microprocessor-based vehicle and/or powertrain controller, such as controller 32. Of course, the control logic may be implemented in software, hardware, or a combination of software and hardware in one or more controllers depending upon the particular application. When implemented in software, the control logic may be provided in one or more computer-readable storage devices or media having stored data representing code or instructions executed by a computer to control the vehicle or its subsystems. The computer-readable storage devices or media may include one or more of a number of known physical devices which utilize electric, magnetic, and/or optical storage to keep executable instructions and associated calibration information, operating variables, and the like.

An accelerator pedal 34 is used by the driver of the vehicle to provide a demanded torque, power, or drive command to the powertrain 12 (or more specifically M/G 14) to propel the vehicle. In general, depressing and releasing the accelerator pedal 34 generates an accelerator pedal position signal that may be interpreted by the controller 32 as a demand for increased power or decreased power, respectively. A brake pedal 36 is also used by the driver of the vehicle to provide a demanded braking torque to slow the vehicle. In general, depressing and releasing the brake pedal 36 generates a brake pedal position signal that may be interpreted by the controller 32 as a demand to decrease the vehicle speed. Based upon inputs from the accelerator pedal 34 and brake pedal 36, the controller 32 commands the torque and/or power to the M/G 14, and friction brakes 38. The controller 32 also controls the timing of gear shifts within the transmission 16.

The M/G 14 may act as a motor and provide a driving force for the powertrain 12.

To drive the vehicle with the M/G 14 the traction battery 22 transmits stored electrical energy through wiring 40 to the power electronics 24 that may include inverter and rectifier circuitry, for example. The inverter circuitry of the power electronics 24 may convert DC voltage from the battery 22 into AC voltage to be used by the M/G 14. The rectifier circuitry of the power electronics 24 may convert AC voltage from the M/G 14 into DC voltage to be stored with the battery 22. The controller 32 commands the power electronics 24 to convert voltage from the battery 22 to an AC voltage provided to the M/G 14 to provide positive or negative torque to the input shaft 18.

The M/G 14 may also act as a generator and convert kinetic energy from the powertrain 12 into electric energy to be stored in the battery 22. More specifically, the M/G 14 may act as a generator during times of regenerative braking in which torque and rotational (or kinetic) energy from the spinning wheels 28 is transferred back through the transmission 16 and is converted into electrical energy for storage in the battery 22.

It should be understood that the vehicle configuration described herein is merely exemplary and is not intended to be limited. Other electric or hybrid electric vehicle configurations should be construed as disclosed herein. Other electric or hybrid vehicle configurations may include, but are not limited to, series hybrid vehicles, parallel hybrid vehicles, series-parallel hybrid vehicles, plug-in hybrid electric vehicles (PHEVs), fuel cell hybrid vehicles, battery operated electric vehicles (BEVs), or any other vehicle configuration known to a person of ordinary skill in the art.

In hybrid configurations that include an internal combustion engine such as a gasoline, diesel, or natural gas powered engine, or a fuel cell, the controller 32 may be configured to control various parameters of such an internal combustion engine. Representative examples of internal combustion parameters, systems, and/or components that may be directly or indirectly actuated using control logic and/or algorithms executed by the controller 32 include fuel injection timing, rate, and duration, throttle valve position, spark plug ignition timing (for spark-ignition engines), intake/exhaust valve timing and duration, etc. Sensors communicating input through the I/O interface from such an internal combustion engine to the controller 32 may be used to indicate turbocharger boost pressure, crankshaft position (PIP), engine rotational speed (RPM), intake manifold pressure (MAP), throttle valve position (TP), exhaust gas oxygen (EGO) or other exhaust gas component presence, intake air flow (MAF), etc.

It should be understood that the schematic illustrated in FIG. 1 is merely representative and is not intended to be limiting. Other configurations are contemplated without deviating from the scope of the disclosure. For example, the vehicle powertrain 12 may be configured to deliver power and torque to the one or both of the front wheels as opposed to the illustrated rear wheels 28.

An estimated power capability of a battery in a hybrid or electric vehicle (e.g., battery 22) may be difficult to predict with an equivalent circuit model (ECM) when there is a sudden drop in battery cell voltage, particularly under conditions of a low state of charge (SOC), low battery temperatures, and high current demand.

In an electrified vehicle (e.g., a hybrid or electric vehicle), it is the responsibility of the battery management system to inform the vehicle as to how much power (or current) may be drawn from the high voltage battery. Various vehicles may have different architectures and naming, in this case the battery energy control module (BECM) will be used. The BECM may be included as part of controller 32 as depicted in FIG. 1 or may be a separate controller that may communicate with controller 32.

A BECM may broadcast one or more power limits for charging the battery and one or more power limits for discharging the battery. The power limits are defined as the maximum amount of power the battery can provide (e.g., discharging power to operate the M/G 14) or accept (e.g., power for charging the battery 22) for a specified duration at the present battery state of charge and temperature. If the power limit is obeyed, the battery voltage and current will stay within desired limits. Several factors may be used to determine the allowable power limit, one of which is the power capability of the battery. Other factors may include maximizing drivability, battery health, and diagnostic fault responses.

Battery management systems may measure battery voltage, current, and temperature and must deduce properties of the battery from such measurements. Batteries are nonlinear systems, and the best physics-based electrochemical models are complex and memory intensive, and therefore are not typically installed into the controller or computer memory within a vehicle. Furthermore, sensors may have uncertainties and as do the physical characteristics of a battery. For example, a battery may change in capacity by 30% or more over the life of the battery. Power capability of a battery changes not only with life, state of charge, and temperature, but also changes depending on how the battery is being used. For example, a battery can provide more power for a short period of time than it can for a long period of time.

A BECM may estimate power capability using equivalent circuit models and reduced order electrochemical models. Some variety of a Kalman filter, such as an extended Kalman filter (EKF) may be utilized to learn the parameters of such models, particularly equivalent circuit models. Extended Kalman filters may be used due to the nonlinear nature of such models.

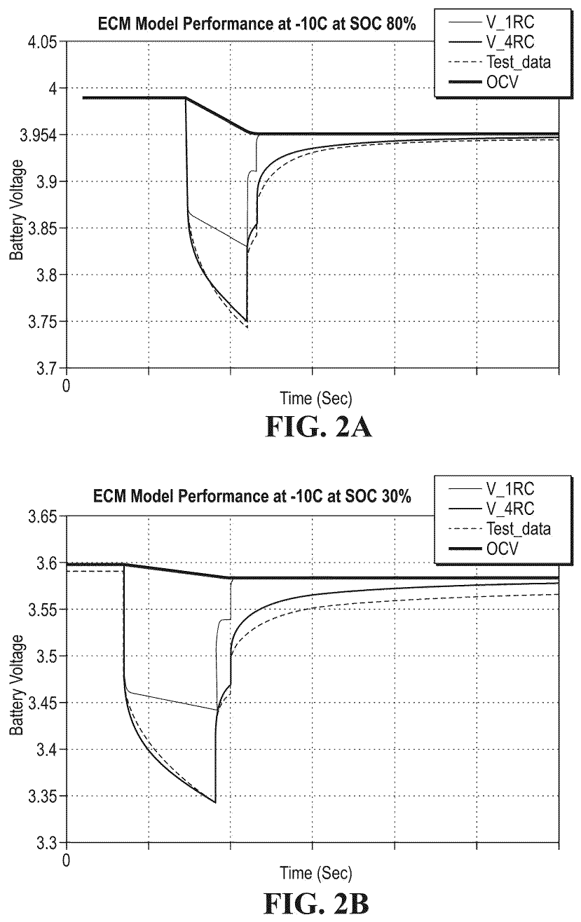

In certain situations, especially at higher currents, lower states of charge and lower temperatures, sudden voltage drops can occur, usually attributed to the loss of active material on the surface of the cell, caused by removing and/or reacting active material faster than more active material can diffuse to the surface. This behavior lacks case-to-case repeatability, preventing the development of a consistent battery model. More importantly, during voltage collapse events, the second-order differential of voltage changes direction, representing a behavior that cannot be captured by the resistor-capacitor (RC) pairs of an ECM. This is illustrated in FIGS. 2A-2D, where a 4RC model (a battery model having four RC pairs) adequately represents battery voltage during current flow until the voltage drops below a limit and/or accelerating the voltage drop speed when the current load remains unchanged. However, the 4RC model does not accurately represent cell performance at lower SOC during voltage collapse (e.g., FIG. 2D). Consequently, the power capability estimated based on the ECM alone may overestimate the power capability of a battery during instances of rapid voltage drops.

As depicted in FIGS. 2A-2D, the ECM error increases as the SOC decreases below a specific threshold, such as 20%. The error grows larger as the SOC further decreases when below the SOC threshold, affecting the accuracy of the estimated battery power capability in the SOC region. While the issue is illustrated using an ECM in FIGS. 2A-2D, it is also applicable to other types of models, such as physical-based models. The 4RC model is compared to the open circuit voltage (OCV), a 1RC model (a battery model having one RC pair), and measured data obtained through testing (e.g., test data) at various SOCs in FIGS. 2A-2D at a low battery temperature (e.g., −10° C.).

Typically, the estimated power capability of a battery falls within the range of (1−αL, 1+αH) of the true power capability of the battery, where αL and αH denote the estimation confidence level which may be determined via offline comparation utilizing test data in the product developing process. Therefore, as the confidence level of the estimated power capability decreases in response to increases in the error, the range of (1-αL, 1+αH) will widen.

If the ECM uses state of charge as an aid to determine ECM parameters, any errors in the SOC may lead to errors in the predicted power capability. For example, if the ECM uses SOC to detect the V0 or OCV parameter, a situation may arise where estimated SOC is higher than the actual SOC resulting in overestimation of the power capability of the battery, the magnitude of which depends on the slope of the OCV/SOC curve. For most chemistries, this slope is highest at very low states of charge.

The basic discharge power limit from power capability of the battery to reduce the probability that the voltage and the current limits will not be exceeded may be calculated using the equation (1):

$$Discharge Power Limit or Discharge Power Threshold = * estimated power capability \qquad ( 1 )$$

where [symbol] is a safety factor. [symbol] may be set to 0.95 when the requirement for discharge dower limits is within 90% to 100% of the battery's true power capability during the vehicle driving process.

Utilizing safety factor [symbol] alone has limitations. For example, the limitation of the battery model (e.g., ECM), may be able to predict power capability when there is a sudden battery voltage drop as described above, which could result in overestimating the power capability of the battery. As another example, during vehicle operation, the estimated power capability of the BECM should always be less than or equal to the battery's true power capability. If the power capability is overestimated, the voltage or current limits of the battery may be violated, which could compromise the integrity of the battery or result in the vehicle shutting down. This implies a constraint that needs to be followed: [symbol] (1+α_H)<1. In real-world operations, the confidence level of the estimated power capability varies across different SOC ranges. The confidence level is higher in mid to high SOC ranges, resulting in smaller values of αL and αH. As we described above, in lower SOC ranges, the confidence level is lower, leading to larger values of αL and αH. This variability can lead to the constraint of [symbol] (1+αH)<1 being more easily violated in lower SOC ranges if a constant value of [symbol] is utilized.

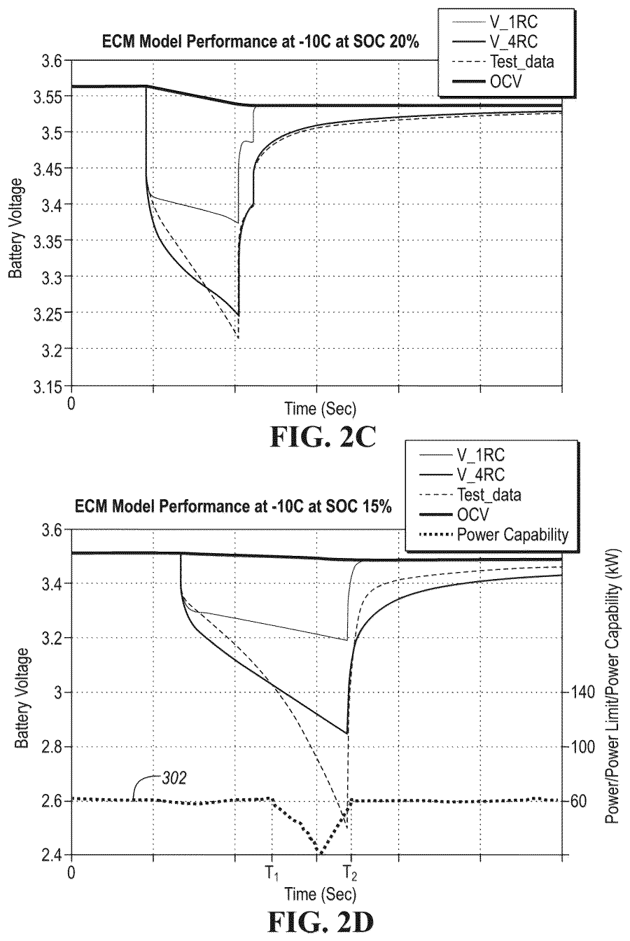

Referring to FIG. 3, a schematic illustration of an ECM that is representative of a battery (e.g., battery 22) is illustrated. More specifically, the ECM may be a 4RC model. The model incorporates various resistors, capacitors, and voltage nodes to simulate the battery's response to different operating conditions. In the model, R₀ represents the internal ohmic resistance of the battery, which accounts for the instantaneous voltage drop when a current (I) flows through the circuit. The voltage drop across R₀ is labeled as V₀. This resistance captures the immediate effects of internal losses due to ion movement and electrical contact resistance within the battery.

The remaining components within the ECM represent the slower, time-dependent behaviors of the battery. Each resistor (R₁) is paired with a capacitor (e.g., τ₁/R₁, (γT₁)τ₁/R₁, αγτ₁²/R₁, or α²γτ₁²/R₁), forming RC networks that represent the battery's diffusion and relaxation processes. Here, τ₁ denotes the time constant of the RC pairs of the battery with the fastest response out of the RC pairs, influencing how quickly the battery reacts to changes in current. Also, here a is associated with the Warburg impedance, indicating the influence of diffusion processes within the battery's electrodes. The parameter γ is a scaling factor that adjusts the time constants of other RC pairs with slower responses, representing variations in the dynamic behavior of the battery under different conditions, such as changes in SOC or temperature. The voltage drops across each RC network are indicated as V₁, V₂, V₃, and V₄, which collectively contribute to the overall dynamic response of the battery.

V_{battery} represents the terminal voltage, which is the net output voltage after accounting for all internal resistances and dynamic processes. This ECM effectively captures both the instantaneous voltage drop due to R₀ and the more gradual changes due to electrochemical dynamics within the battery, providing a useful tool for simulating and predicting battery performance under various operating conditions.

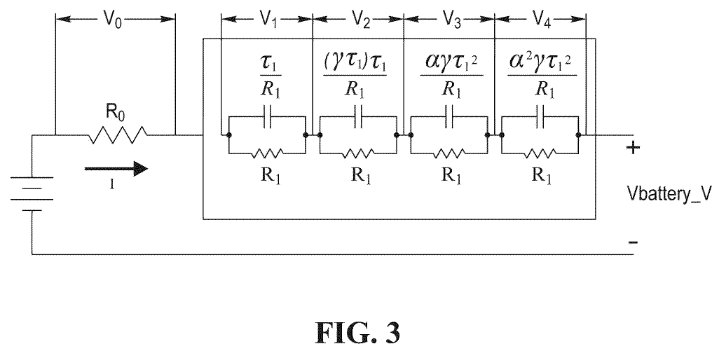

Referring to FIG. 4, a flowchart of a method 100 of estimating the power output limit or power capability of the battery (e.g., battery 22) is illustrated. The method 100 may be stored as control logic and/or an algorithm within the controller 32. The controller 32 may implement the method 100 by controlling the various components of the vehicle 10.

The method 100 utilizes voltage feedback control to address the overestimation of discharge power capability to accurately estimate battery power capability dtrops during a discharge operation of the battery. The estimated power capability may be based on the ECM and is adjusted based on Proportional and/or Differential (PD) feedback control of the terminal voltage of the battery. Some variety of a Kalman filter, such as an Extended Kalman Filter (EKF) may be used to learn the parameters of the ECM. If the battery voltage drops below a voltage limit, which is temperature dependent, proportional control is used to adjust the estimated power capability lower. If the battery voltage drop speed (defined as the derivative of the battery voltage difference) exceeds a temperature-dependent voltage drop speed limit, differential control is used to reduce the estimated power capability. If both the battery voltage and voltage drop speed exceed their limits, the Proportional and Differential (PD) control is applied to adjust the estimated power capability.

The method 100 begins at block 102, where the estimated power capability of the battery (Estimated Power Capability Based EKF/ECM(t)), battery terminal voltage (Battery_V(t)), and the battery temperature (T(t)) are input into the controller. The terminal voltage (Battery_V(t)) and the battery temperature (T(t)) may be measured via sensors while the estimated power capability is based on the ECM adjusted via the EKF. It is noted that although the ECM depicted herein includes four RC pairs, the ECM utilized in the method 100 may include any number RC pairs or may be another type of model, such as reduced order and/or electrochemical models.

Next, the method 100 moves onto block 104, where a voltage limit or threshold (Voltage_Limit (T)(t))), a voltage rate limit or threshold (Voltage_Drop_Speed_Limit (T)(t)), and a voltage drop speed ((Battery_V(t)−Battery(t−dt))/dt) are calculated. The voltage drop speed (Voltage_Drop_Speed=(Battery_V(t)−Battery(t−dt))/dt) corresponds to a rate at which the voltage of the battery changes, which may be deduced via measuring the terminal voltage of the battery. The voltage limit or threshold (Voltage_Limit (T)(t))) and voltage rate limit or threshold (Voltage_Drop_Speed_Limit (T)(t)) are each functions of a temperature of the battery. The voltage limit or threshold (Voltage_Limit (T)(t))) and voltage rate limit or threshold (Voltage_Drop_Speed_Limit (T)(t)) may each have a linear relationship to the temperature of the battery. The voltage limit or threshold (Voltage_Limit (T)(t))) and voltage rate limit or threshold (Voltage_Drop_Speed_Limit (T)(t)) may either increase or decrease as the battery temperature increases or decreases.

The method 100 next moves on to block 106, where it is determined if the voltage of the battery (e.g., the measured the terminal voltage of the battery or as determined by the ECM) is less than the voltage limit or threshold (Voltage_Limit (T)(t))). The output of block 106 determines the parameter r_P, which is set at either block 108 or block 110. If the voltage of the battery (e.g., the measured the terminal voltage of the battery) is not less than the voltage limit or threshold (Voltage_Limit (T)(t))), r_P is set to zero at block 108. If the voltage of the battery (e.g., the measured the terminal voltage of the battery or as determined by the ECM) is less than the voltage limit or threshold (Voltage_Limit (T)(t))), r_P is set to a value at block 110 that is proportional to the difference between the voltage of the battery (e.g., the measured the terminal voltage of the battery) and the voltage limit or threshold (Voltage_Limit (T)(t))). More specifically, r_P may be represented by the equation (2):

$$r\_P = Pp * ( Voltage\_Limit ( T ) ( t ) ) - Voltage of the Battery ) \qquad ( 2 )$$

where Pp is a proportional calibrated value. It noted that r_P is less or equal to one and greater than or equal to zero in all circumstances. Please note that each value between zero and one, including fractional values, for r_P may be representative of a percentage. For example, 1 may be representative of 100%, 0.50 may representative of 50%, 0.25 may representative of 25%, 0.125 may representative of 12.5%, 0 may representative of 0%, etc.

The r_P value is then input into block 112 by either block 108 or block 110 depending on the outcome at block 106. The r_P value represents the proportional control parameter of the method 100.

The method 100 also moves on to block 114 from block 104, wherein it is determined if a filtered value of a rate of change in a current of the battery (di/dt) is less than a current rate limit (di_lim) and if an absolute and filtered value of the rate at which the voltage of the battery changes (Voltage_Drop_Speed) is greater than the voltage rate limit or threshold (Voltage_Drop_Speed_Limit (T)(t)). The current of the battery (di/dt) and the rate at which the voltage of the battery changes (Voltage_Drop_Speed) may be filtered by a Savizty-Golay filter other filter to eliminate or reduce noise.

The output of block 114 determines the parameter r_D, which is set at either block 116 or block 118. If the filtered value of the rate of change in the current of the battery (di/dt) is not less than the current rate limit (di_lim) and if the absolute and filtered value of the rate at which the voltage of the battery changes (Voltage_Drop_Speed) is not greater than the voltage rate limit or threshold (Voltage_Drop_Speed_Limit (T)(t)), r_D is set to zero at block 116. If the filtered value of the rate of change in a current of the battery (di/dt) is less than the current rate limit (di_lim) and if the absolute and filtered value of the rate at which the voltage of the battery changes (Voltage_Drop_Speed) is greater than the voltage rate limit or threshold (Voltage_Drop_Speed_Limit (T)(t)), r_D is set to a value at block 118 that is proportional to the difference between the rate at which the voltage of the battery changes (Voltage_Drop_Speed) and the voltage rate limit or threshold (Voltage_Drop_Speed_Limit (T)(t)). More specifically, r_D may be represented by the equation (3):

$$r\_D = Pd * ( Voltage\_Drop \_Speed - Voltage\_Drop \_Speed \_Limit ( T ) ( t ) ) \qquad ( 3 )$$

where Pd is a proportional calibrated value. It noted that r_D is less than or equal to one and greater than or equal to zero in all circumstances. Please note that each value between zero and one, including fractional values, for r_D may be representative of a percentage. For example, 1 may be representative of 100%, 0.50 may representative of 50%, 0.25 may representative of 25%, 0.125 may representative of 12.5%, 0 may representative of 0%, etc.

The r_D value is then input into block 112 by either block 116 or block 118 depending on the outcome at block 114. The r_D value represents the derivative or differential control parameter of the method 100.

At block 118, an adjustment parameter (r_Vdrop) to the estimated power capability of the battery (Estimated Power Capability Based EKF/ECM(t)) is calculated. The adjustment parameter (r_Vdrop) may be a percentage of the estimated power capability of the battery (Estimated Power Capability Based EKF/ECM(t)). The adjustment parameter (r_Vdrop) may be represented by equation (4):

$$r\_Vdrop = 1 - r\_P - r\_D \qquad ( 4 )$$

The sum of r_P and r_D (i.e., r_P+r_D) is less or equal to one and greater than or equal to zero in all circumstances. Therefore, r_Vdrop will also be less or equal to one and greater than or equal to zero in all circumstances. Please note that each value between zero and one, including fractional values, for r_P+r_D may be representative of a percentage. For example, 1 may be representative of 100%, 0.50 may representative of 50%, 0.25 may representative of 25%, 0.125 may representative of 12.5%, 0 may representative of 0%, etc.

Next, the method moves onto to block 120 where the estimated power capability of the battery (Estimated Power Capability Based EKF/ECM(t)) is adjust by multiplying the estimated power capability of the battery (Estimated Power Capability Based EKF/ECM(t)) by the adjustment parameter (r_Vdrop), which may be represented by equation (5):

$$Adjusted Power Capability = ( Estimated Power Capability Based EKF / ECM ( t ) ) * r\_Vdrop \qquad ( 5 )$$

where the Adjusted Power Capability represents the power capability of the battery once adjusted by r_Vdrop.

Since r_Vdrop will also be less or equal to one and greater than or equal to zero in all circumstances, r_Vdrop will either operate to make no change to the estimated power capability of the battery (Estimated Power Capability Based EKF/ECM(t)) or will reduce the estimated power capability of the battery (Estimated Power Capability Based EKF/ECM(t)) to a percentage of an original value. Zero values of both r_P and r_D, will result in no change to the estimated power capability of the battery (Estimated Power Capability Based EKF/ECM(t)). Non-zero values of both r_P and r_D will result in an adjustment (e.g., a reduction) to the power capability of the battery (Estimated Power Capability Based EKF/ECM(t)) from both r_P and r_D to a percentage of an original value of the power capability of the battery, where the percentage is complimentary to the sum of r_P and r_D. A zero value of r_P and a non-zero value of r_D will result in an adjustment (e.g., a reduction) to the power capability of the battery (Estimated Power Capability Based EKF/ECM(t)) from r_D only to a percentage of an original value of the power capability of the battery, where the percentage is complimentary to r_D only. A zero value of r_D and a non-zero value of r_P will result in an adjustment (e.g., a reduction) to the power capability of the battery (Estimated Power Capability Based EKF/ECM(t)) from and r_P only to a percentage of an original value of the power capability of the battery, where the percentage is complimentary to r_P only.

It should be understood that the flowchart in FIG. 4 is for illustrative purposes only and that the method 100 should not be construed as limited to the flowchart in FIG. 4. Some of the steps of the method 100 may be rearranged while others may be omitted entirely.

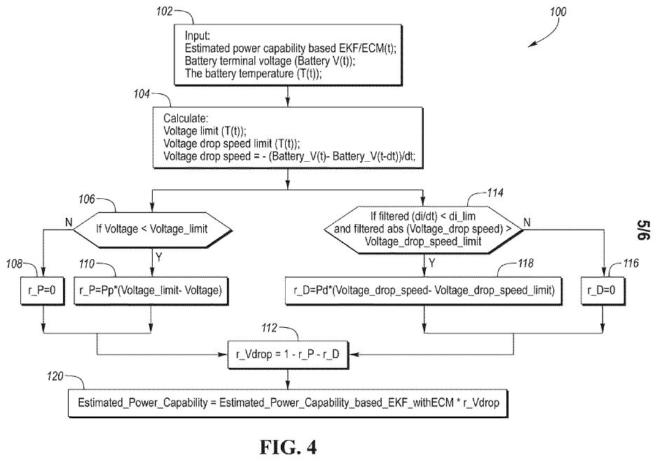

Referring to FIG. 5, a flowchart illustrating a method 200 for controlling the power output of the battery (e.g., battery 22) by implementing method 100 is illustrated. The method 200 may be stored as control logic and/or an algorithm within the controller 32. The controller 32 may implement the method 200 by controlling the various components of the vehicle 10. The method 200 represents a use case scenario where the battery 22 is operating at or near the power output limits of the battery (e.g., see equation (1)). Under such a scenario, a decrease in the power capability of the battery (Estimated Power Capability Based EKF/ECM(t)) via r_P (i.e., proportional control parameter) and/or r_D (i.e., derivative control parameter) will also result in a decrease in the power output of the battery due to the power capability of the battery (Estimated Power Capability Based EKF/ECM(t)) decreasing to less than a commanded power output of the battery.

The method 200 begins at block 202, where a command to deliver power to the M/G 14 from the battery 22 is generated. Next, the method 200 moves on to block 204, wherein it is determined if the voltage of the battery 22 is less than a first threshold (e.g., Voltage_Limit (T)(t))) and/or if a rate of change in the voltage of the battery 22 exceeds a second threshold (e.g., Voltage_Drop_Speed_Limit (T)(t))). If the voltage of the battery 22 is not less than the first threshold and the rate of change in the voltage of the battery 22 does not exceeds the second threshold, the method 200 moves onto block 206 where the power delivered from the battery 22 to the M/G 14 is maintained at the commanded value (e.g., the value commanded at block 202). It is noted that the at block 206, the power being delivered from the battery 22 to the M/G 14 may have a value that is up to Estimated Power Capability Based EKF/ECM(t), where the Estimated Power Capability Based EKF/ECM(t) has not been reduced by a percentage corresponding to the adjustment parameter (r_Vdrop). However, the power output at block 206 may be limited by multiplying the Estimated Power Capability Based EKF/ECM(t) at block 206 by the safety factor [symbol] according to equation (1).

Returning to block 204, if the voltage of the battery 22 is less than the first threshold and/or the rate of change in the voltage of the battery 22 exceeds the second threshold, the method 200 moves onto block 208 where the power delivered from the battery 22 to the M/G 14 is reduced to less than the commanded value (e.g., less than the value commanded at block 202).

At block 208, if both the voltage of the battery 22 is less than the first threshold and the rate of change in the voltage of the battery 22 exceeds the second threshold, the power delivered from the battery 22 to the M/G 14 is reduced to less than the commanded value based on both the proportion of the difference between the first threshold and the voltage of the battery 22 and the proportion of the difference between the rate of change in the voltage of the battery 22 and the second threshold according to method 100, since the battery 22 is operating at or near the power output limits of the battery 22. For example, at block 208, the power delivered from the battery 22 to the M/G 14 is reduced in the same manner as the Estimated Power Capability Based EKF/ECM(t), which is reduced by a percentage corresponding to the adjustment parameter (r_Vdrop), where the adjustment parameter (r_Vdrop) has been adjust by both parameter r_P and parameter r_D since both parameter r_P and parameter r_D will have non-zero values.

At block 208, if the voltage of the battery 22 is less than the first threshold but the rate of change in the voltage of the battery 22 does not exceed the second threshold, the power delivered from the battery 22 to the M/G 14 is reduced to less than the commanded value based on the proportion of the difference between the first threshold and the voltage of the battery 22 only according to method 100, since the battery 22 is operating at or near the power output limits of the battery. For example, at block 208, the power delivered from the battery 22 to the M/G 14 is reduced in the same manner as the Estimated Power Capability Based EKF/ECM(t), which is reduced by a percentage corresponding to the adjustment parameter (r_Vdrop), where the adjustment parameter (r_Vdrop) has been adjust by only parameter r_P, since parameter r_P has a non-zero value while parameter r_D has zero value.

At block 208, if the voltage of the battery 22 is not less than the first threshold but the rate of change in the voltage of the battery 22 does exceed the second threshold, the power delivered from the battery 22 to the M/G 14 is reduced to less than the commanded value based on the proportion of the difference between the rate of change in the voltage of the battery 22 and the second threshold only according to method 100, since the battery 22 is operating at or near the power output limits of the battery. For example, at block 208, the power delivered from the battery 22 to the M/G 14 is reduced in the same manner as the Estimated Power Capability Based EKF/ECM(t), which is reduced by a percentage corresponding to the adjustment parameter (r_Vdrop), where the adjustment parameter (r_Vdrop) has been adjust by only parameter r_D, since parameter r_D has a non-zero value while parameter r_P has zero value.

The method 200 recycles back to block 204 from both block 206 and block 208. This allows the method 200 to transition between blocks 206 and 208 in the event the voltage of the battery 22 crosses the first threshold (e.g., transitions from greater than to less than the first threshold or vice versa) and/or the rate of change in the voltage of the battery 22 crosses the second threshold (e.g., transitions from greater than to less than the second threshold or vice versa), while power is being delivered from the battery 22 to the M/G 14.

It is noted that the power output at block 208 may be further limited by multiplying the Estimated Power Capability Based EKF/ECM(t) as reduced at block 208 by the safety factor [symbol] according to equation (1). It should be understood that the flowchart in FIG. 5 is for illustrative purposes only and that the method 200 should not be construed as limited to the flowchart in FIG. 5. Some of the steps of the method 200 may be rearranged while others may be omitted entirely.

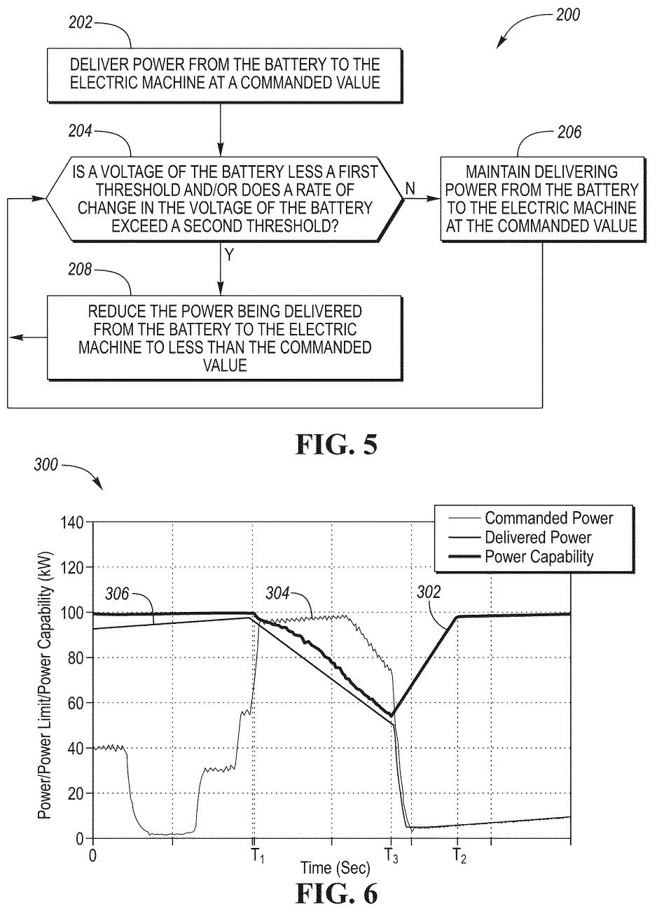

Referring to FIG. 6, a graph 300 of the power output of the battery 22 when controlled based on method 100 and method 200 is illustrated. Line 302 illustrates the Estimated Power Capability Based EKF/ECM(t), which may be reduced by safety factor [symbol] according to equation (1). Line 304 illustrates a commanded power output from the battery 22 to the M/G 14. Line 306 illustrates the actual power delivered from the battery 22 to the M/G 14. Between times T₁ and T₂ the Estimated Power Capability Based EKF/ECM(t) 302 has been reduced relative to the commanded power output 304 by method 100 in response to the voltage of the battery 22 being less than a first threshold (e.g., Voltage_Limit (T)(t))) and/or the rate of change in the voltage of the battery 22 exceeding the second threshold (e.g., Voltage_Drop_Speed_Limit (T)(t))). This is also illustrated in FIG. 2D where the reduction of the Estimated Power Capability Based EKF/ECM(t) 302 occurs simultaneously along with the voltage of the battery 22 being less than a first threshold and the rate of change in the voltage of the battery 22 exceeding the second threshold. The actual power 306 delivered from the battery 22 to the M/G 14 is clipped between times T₁ and T₃ to less than the commanded power output 304 from the battery 22 to the M/G 14 due to the commanded power output 304 being greater than reduced the Estimated Power Capability Based EKF/ECM(t) 302, which illustrates a use case where delivered power is reduced due to a reduction in the Estimated Power Capability Based EKF/ECM(t) 302.

In an alternative method the confidence level of the estimated power capability across varying state of charge (SOC) ranges, temperature conditions, as well as battery life may be utilized to calculate the discharge power limits and charging power limits of the battery from the estimated power capability. This alternative method may be used for both long term and short term power capability. During a discharging scenario of the battery 22, the discharge power limits of the battery 22 may be based on the estimated power capability of the battery 22 according to equations (6) and (7):

$$Discharge Power Limits = \_total * estimated discharged power capability \qquad ( 6 )$$

$$\_total = * \_conf \_dis * \_life \qquad ( 7 )$$

where, [symbol] is a safety factor or coefficient that ensures the Discharge Power Limits from Power Capability fall within the range of X % of the battery power capability, [symbol] _conf_dis is an adjustable parameter designed to compensate for increased uncertainty at lower SOC and lower temperature ranges for estimated discharge power capability, and [symbol] _life is a parameter that varies with the battery's life cycle.

[symbol] may be a constant value, such as 0.95. [symbol] _conf_dis is a function of SOC and temperature of the battery 22, denoted as [symbol] _conf_dis=f(SOC, T), and can be represented as a calibrated two-dimensional table (e.g., Table 1) under battery discharging conditions. It is noted [symbol] _conf_dis decreases under discharging conditions of the battery 22 as the temperature of the battery 22 decreases and the SOC of the battery 22 decreases.

TABLE 1

| | | SOC(%) | | | | | | | | |
|---|---|---|---|---|---|---|---|---|---|---|
| T° C. | | 0% | 5% | 10% | 20% | 30% | 40% | 50% | 95% | 100% |
| −40° | C. | 0.6 | 0.8 | 0.84 | 0.88 | 0.9 | 0.9 | 0.9 | 0.9 | 0.9 |
| −30° | C. | 0.7 | 0.85 | 0.91 | 0.93 | 0.95 | 0.95 | 0.95 | 0.95 | 0.95 |
| −20° | C. | 0.8 | 0.9 | 0.94 | 0.98 | 0.98 | 0.98 | 0.98 | 0.98 | 0.98 |
| −10° | C. | 0.82 | 0.92 | 0.96 | 1 | 1 | 1 | 1 | 1 | 1 |
| 0° | C. | 0.85 | 0.94 | 0.98 | 1 | 1 | 1 | 1 | 1 | 1 |
| 10° | C. | 0.85 | 0.96 | 1 | 1 | 1 | 1 | 1 | 1 | 1 |
| 25° | C. | 0.85 | 0.96 | 1 | 1 | 1 | 1 | 1 | 1 | 1 |
| 45° | C. | 0.85 | 0.96 | 1 | 1 | 1 | 1 | 1 | 1 | 1 |
| 60° | C. | 0.85 | 0.96 | 1 | 1 | 1 | 1 | 1 | 1 | 1 |

[symbol] _life initially, in a new life cycle, [symbol] _life may be set to one. As the battery's life progresses, [symbol] _life may decrease from one but will always remain greater than zero. During a charging scenario of the battery 22, the charge power limits of the battery may be based on the power capability of the battery according to equations (8) and (9):

$$Charge Power Limits = \_total * estimated charged power capability \qquad ( 8 )$$

$$\_total = * \_conf \_charge * \_life \qquad ( 9 )$$

[symbol] _conf_charge is an adjustable parameter designed to compensate for increased uncertainty at higher SOC and lower temperature ranges for estimated charge power capability. It is a function of SOC and temperature of the battery, denoted as [symbol] _conf_charge=f(SOC, T), and can be represented as a calibrated two-dimensional table (e.g., Table 2) under battery charging conditions. It is noted [symbol] _conf_charge decreases under charging conditions of the battery 22 as the temperature of the battery 22 decreases and the SOC of the battery 22 increases.

TABLE 2

| | | SOC(%) | | | | | | | | |
|---|---|---|---|---|---|---|---|---|---|---|
| T° C. | | 0% | 5% | 10% | 20% | 30% | 40% | 50% | 95% | 100% |
| −40° | C. | 0.6 | 0.8 | 0.84 | 0.88 | 0.9 | 0.9 | 0.9 | 0.9 | 0.85 |
| −30° | C. | 0.7 | 0.85 | 0.91 | 0.93 | 0.95 | 0.95 | 0.95 | 0.95 | 0.9 |
| −20° | C. | 0.8 | 0.9 | 0.94 | 0.98 | 0.98 | 0.98 | 0.98 | 0.98 | 0.92 |
| −10° | C. | 0.82 | 0.92 | 0.96 | 1 | 1 | 1 | 1 | 1 | 0.96 |
| 0° | C. | 0.85 | 0.94 | 0.98 | 1 | 1 | 1 | 1 | 1 | 0.96 |
| 10° | C. | 0.85 | 0.96 | 1 | 1 | 1 | 1 | 1 | 1 | 0.96 |
| 25° | C. | 0.85 | 0.96 | 1 | 1 | 1 | 1 | 1 | 1 | 0.96 |
| 45° | C. | 0.85 | 0.96 | 1 | 1 | 1 | 1 | 1 | 1 | 0.96 |
| 60° | C. | 0.85 | 0.96 | 1 | 1 | 1 | 1 | 1 | 1 | 0.96 |

The alternative method including equations (6)-(9), Table 1, and Table 2 may be stored as control logic and/or an algorithm within the controller 32. The controller 32 may implement the alternative method by controlling the various components of the vehicle 10.

It should be understood that the designations of first, second, third, fourth, etc. for any component, state, or condition described herein may be rearranged in the claims so that they are in chronological order with respect to the claims. Furthermore, it should be understood that any component, state, or condition described herein that does not have a numerical designation may be given a designation of first, second, third, fourth, etc. in the claims if one or more of the specific component, state, or condition are claimed.

The words used in the specification are words of description rather than limitation, and it is understood that various changes may be made without departing from the spirit and scope of the disclosure. As previously described, the features of various embodiments may be combined to form further embodiments that may not be explicitly described or illustrated. While various embodiments could have been described as providing advantages or being preferred over other embodiments or prior art implementations with respect to one or more desired characteristics, those of ordinary skill in the art recognize that one or more features or characteristics may be compromised to achieve desired overall system attributes, which depend on the specific application and implementation. As such, embodiments described as less desirable than other embodiments or prior art implementations with respect to one or more characteristics are not outside the scope of the disclosure and may be desirable for particular applications.

What is claimed is:

1. A vehicle comprising:
a battery configured to deliver power to an electric machine to propel the vehicle; and
a controller programmed to,
while discharging power from the battery at a commanded value and in response to a rate of change of a voltage of the battery increasing to greater than a threshold rate during the discharging, reduce the discharging power to less than the commanded value based on a proportion of a difference between the rate and the threshold rate, and
while discharging power from the battery at the commanded value and in response to the rate remaining less than the threshold rate during the discharging, maintain discharging the battery at the commanded value.

2. The vehicle of claim 1, wherein reducing the discharging power to less than the commanded value corresponds to reducing the discharging power to a percentage of the commanded value, wherein the percentage is complimentary to the proportion of the difference between the rate and the threshold rate.

3. The vehicle of claim 1, wherein the controller is further programmed to, in response to discharging power from the battery at the commanded value and the voltage of the battery decreasing to less than a voltage threshold during the discharging, reduce the discharging power from the commanded value to less than the commanded value based on a proportion of a difference between the voltage threshold and the voltage.

4. The vehicle of claim 3, wherein the controller is further programmed to, in response to discharging power from the battery at the commanded value and the voltage of the battery remaining greater than the voltage threshold during the discharging, maintain discharging the battery at the commanded value.

5. The vehicle of claim 3, wherein reducing the discharging power to less than the commanded value corresponds to reducing the discharging power to a percentage of the commanded value, wherein the percentage is complimentary to the proportion of the difference between the voltage threshold and the voltage.

6. The vehicle of claim 1, wherein the voltage is based on a measured value.

7. The vehicle of claim 1, wherein the threshold rate is a function of a temperature of the battery.

8. A vehicle comprising:
an electric machine;
a battery configured to deliver power to the electric machine to propel the vehicle; and
a controller programmed to, in response to (i) a voltage of the battery decreasing to less than a first threshold while the battery is discharging and (ii) a rate of change of the voltage increasing to greater than a second threshold during the discharging, reduce a discharging power of the battery based on (a) a proportion of a difference between the first threshold and the voltage and (b) a proportion of a difference between the rate and the second threshold.

9. The vehicle of claim 8, wherein the controller is programmed to, in response to (i) the voltage of the battery remaining greater than the first threshold and (ii) the rate of change of the voltage increasing to greater than the second threshold, reduce the discharging power of the battery based on the proportion of the difference between the rate and the second threshold only.

10. The vehicle of claim 8, wherein the controller is programmed to, in response to (i) the voltage of the battery decreasing to less than the first threshold and (ii) the rate of change of the voltage remaining less than the second threshold, reduce the discharging power of the battery based on the proportion of the difference between the first threshold and the voltage only.

11. The vehicle of claim 8, wherein the controller is programmed to, in response to (i) the voltage of the battery remaining greater than the first threshold and (ii) the rate of change of the voltage of the battery remaining less than the second threshold, maintain a current discharging power of the battery.

12. The vehicle of claim 8, wherein reducing the discharging power corresponds to reducing the discharging power to a percentage of a current value, wherein the percentage is complimentary to a sum of (i) the proportion of the difference between the first threshold and the voltage and (ii) the proportion of the difference between the rate and the second threshold.

13. The vehicle of claim 8, wherein the voltage is based on a measured value.

14. A vehicle comprising:
a battery configured to deliver power to an electric machine to propel the vehicle; and
a controller programmed to, while discharging power from the battery at a commanded value and in response to a voltage of the battery decreasing to less than a voltage threshold during the discharging, reduce the discharging power from the commanded value to less than the commanded value based on a proportion of a difference between the voltage threshold and the voltage.

15. The vehicle of claim 14, wherein the controller is further programmed to, while discharging power from the battery at the commanded value and in response to the voltage of the battery remaining greater than the voltage threshold during the discharging, maintain discharging the battery at the commanded value.

16. The vehicle of claim 14, wherein reducing the discharging power to less than the commanded value corresponds to reducing the discharging power to a percentage of the commanded value, wherein the percentage is complimentary to the proportion of the difference between the voltage threshold and the voltage.

17. The vehicle of claim 14, wherein the controller is further programmed to, in response to discharging power from the battery at the commanded value and a rate of change of the voltage of the battery increasing to greater than a threshold rate during the discharging, reduce the discharging power to less than the commanded value based on a proportion of a difference between the rate and the threshold rate.

18. The vehicle of claim 17, wherein the controller is further programmed to, in response to discharging power from the battery at the commanded value and the rate remaining greater than the threshold rate during the discharging, maintain discharging the battery at the commanded value.

19. The vehicle of claim 17, wherein reducing the discharging power to less than the commanded value corresponds to reducing the discharging power to a percentage of the commanded value, wherein the percentage is complimentary to the proportion of the difference between the rate and the threshold rate.

20. The vehicle of claim 14, wherein the voltage threshold is a function of a temperature of the battery.
